(19) United States
(12) Patent Application Publication
(10) Pub. No.: US 2009/0018938 A1
(43) Pub. Date: Jan. 15, 2009

(54) SYSTEMS AND METHODS FOR PREDICTIVE BILL ENTRY

(76) Inventors: John Bollinger, Lewis Center, OH (US); Jeff Fobean, Stow, OH (US); Poi Shen, Copley, OH (US); John Fleck, Bethlehem, PA (US)

Correspondence Address: FULBRIGHT & JAWORSKI, LLP, 1301 MCKINNEY, SUITE 5100, HOUSTON, TX, 77010-3095, US

(21) Appl. No.: 12/171,964

(22) Filed: Jul. 11, 2008

Related U.S. Application Data
(60) Provisional application No. 60/949,184, filed on Jul. 11, 2007.

(51) Int. Cl. H04M 15/00

(52) U.S. Cl. 705/34

(57) ABSTRACT

A system and methods for the processing of documents generated in shipping transactions using predictive data entry is disclosed. The system utilizes a Predicted Bill Entry engine and database to shift from a bill entry process to a bill review process by predicting the shipment characteristics between common sender and receiver pairs. Shipping information collected at the time of pickup or quote is converted into a temporary shipment record. The engine then compares the temporary shipment record with the predictive bill entry database. If a match is found, the user will be presented with a predictive record for bill review. Alternatively, the user can use the Predicted Bill Entry engine by entering the certain shipping information. The Predicted Bill Entry engine searches for a match in the Predicted Bill Entry database. If a match is found, the user is presented with a predictive record for bill review.

### CROSS-REFERENCE TO RELATED APPLICATIONS

This application is a Non-Provisional of Provisional (35 USC 119(e)) application 60/949,184 filed on Jul. 11, 2007, which is incorporated by reference herein in its entirety.

### TECHNICAL FIELD

The present invention relates to the shipment of goods in general, document management and more specifically to the processing of documents, such as waybills, bills of lading, or delivery receipts, generated in the shipment transactions. The present invention provides a method for computer assisted bill entry for processing the shipping transactions to reduce cycle time, initial clerical costs for bill entry, and reduce revenue adjustments related to bill entry errors.

### BACKGROUND OF THE INVENTION

Commercial carriers of goods, such as trucking companies, railroads, air freight services, or ocean-going shipping companies, generate large quantities of paper documents to record and process the many individual shipments handled each day. A particular carrier will generally serve numerous customers, which impose varied document-handling demands on the carrier. The customers dealing with a carrier may vary, for example, from an individual desiring to ship a single package, to a large company with bulk shipments, or even another commercial carrier such as a trucking company delivering to a railroad or ocean-going vessel. The entity desiring to transport an article by means of a commercial carrier is generally referred to herein as the shipper. The intended recipient of that article from the commercial carrier is generally referred to herein as the consignee.

The nature and magnitude of the paper-handling problem may be appreciated by reference to the operations of a trucking company. A trucking company may handle as many as 1,000,000 shipping transactions per month. To handle the large number of shipments with diverse origins and destinations, some trucking companies maintain a plurality of local freight terminals having localized service areas for the pickup and delivery of shipments from or to shippers and consignees. The local terminals may transport shipments to or receive shipments from a smaller number of regional consolidation centers, which may be pictured as forming the hubs of regional wheels while the associated local terminals form the spokes of the wheels. The consolidation centers themselves may also receive and deliver shipments directly from and to shippers and consignees.

A party desiring to make a shipment may bring the goods to a local terminal, or may call upon the services of a local transportation company to pick up the shipment and deliver it to the carrier's local terminal, or the carrier itself may pick up the shipment at the shipper's facility. The various packages dropped off at the terminal are loaded onto a truck either for local delivery or for transportation to the regional consolidation center. There the packages may be transloaded to other trucks for shipment to other local terminals or transloaded to long-haul trucks and transshipped over great distances to other consolidation centers. At additional consolidation centers the load is again transloaded to other trucks going out to the various destination terminals fed by these consolidation centers. The various packages are then delivered to the intended consignees, or the consignees themselves arrange to pick up the shipments at the destination terminal.

The shipment of goods in the above manner is accompanied by a large amount of paperwork. If the shipping party is a commercial entity, then the shipment would typically be made pursuant to a purchase order to the shipper from the consignee. When the goods are picked up at the shipping company, the truck driver typically receives a bill of lading identifying the package or packages being shipped. At the local freight terminal, the truck driver delivers a copy of the bill of lading to a clerk to begin the paper trail.

To assist in keeping track of the many thousands of shipments per day, each shipment is assigned a unique number. In some cases, the truck drivers are provided with pre-printed stickers with a progressive sequence of numbers printed on them, referred to generally as progressive routing order numbers. A sufficient number of duplicate stickers with the same progressive routing order number are printed so that when the goods are first picked up, the truck driver may apply a sticker to the individual packages making up the shipment and to multiple copies of the bill of lading. In some cases, the progressive routing order number is assigned by the trucking company's computer at the time that shipment information is first entered. In either case the progressive routing order number is used to index and identify the goods and the accompanying documents as they make their way through the delivery network.

In a typical computer-controlled accounting and billing system, a clerk, who may be located at the local freight terminal, keys the progressive routing order number and other information from the bill of lading at a computer terminal for entry into the company's main computer, which is typically located at a remote site such as the company headquarters. The data from the bill of lading are also used to determine the route, the necessary transhipments and the like, which the shipment will follow to its destination terminal.

When the shipment is delivered to the consignee, or picked up at the destination terminal by the consignee, the consignee is presented with a delivery receipt for signature. The executed delivery receipt provides proof that the shipment was completed. Sometimes the lading freight bill (i.e., with freight charges indicated) is used for this purpose; usually, however, a separate receipt is provided similar in form to the shipment invoice, but without the charges shown. When shipment is complete, a bill is sent to the payor (who may be the shipper or the consignee) either from the company's central billing office or from the freight terminal serving the shipper or consignee.

Such a system is subject to a number of drawbacks and problems, including the following: (1) a large clerical labor force is needed to process the paperwork, which adds significantly to the cost of shipment; (2) it is critical that the information from the bill of lading always be entered accurately into the company's computer. Without accurate data entry, errors will appear in the company's billing and record-keeping, and it may become difficult to trace lost shipments.

These problems are not limited to the trucking industry, but arise in analogous forms with the shipment of goods by other modes as well.

### BRIEF SUMMARY OF THE INVENTION

The present invention provides a system and methods for processing the documents generated in shipping transactions that improves the productivity of bill entry while ensuring more accurate data. The system provides for computer assisted bill entry for processing the shipping transactions to reduce cycle time, initial clerical costs for bill entry, and reduce revenue adjustments related to bill entry errors.

In certain embodiments of the invention concerns method for computer assisted bill entry, wherein the method comprises, entering two or more elements of shipping data; creating a temporary shipment record, comparing the elements of shipping data in the temporary shipment record with predictive pairs of shipping data found within the Predictive Bill Entry Engine; creating a Pre-Bill; storing the Pre-Bill data into a Pre-Bill database, and creating a shipping document.

The elements of shipping data may comprise advance connecting line carrier identification code, advance commission agent indicator, codeword, commodity description, company code, consignee customer identification number, consignee city, consignee componentized address, consignee country, consignee name, consignee phone number, consignee state, consignee store number, consignee attention line, consignee zip code, customer type indicator, consignee servicing terminal, cubic feet, density, dimensions, chemical indicator, food indicator, freeze indicator, freeze temperature, payment terms; guaranteed services; handling unit, hazardous material indicator, hazardous material phone number, hazardous material identification number, line item bump indicator, new/used machinery indicator, used machinery released value, shipper servicing terminal, package type, packing list indicator, reference number type, shipper routing carrier identification code, service indicator, shipment purpose, shipper customer identification number, shipper city, shipper componentized address, shipper country, shipper name, shipper phone number, shipper state, shipper store number, shipper load and count indicator, third party attention line, third party customer identification number, third party city, third party componentized address, third party country, third party name, third party state, third party store number, and weight. In specific aspects of the present invention, the elements of shipping data are entered at a data entry station in which the data entry station comprises a computer interface associated with an existing database of the Predictive Bill Entry Engine.

Another aspect of the present invention includes a Predictive Bill Entry Engine, wherein the Predictive Bill Entry Engine comprises the Pre-Bill Database, Predictive Database, Electronic Data Interchange database, ExpressWorks™ database, MyRoadway™, Quoted shipments, Optical Character Recognition, temporary shipment database and pickup appointment system database.

Another embodiment of the present invention includes a method for comparing two or more element of shipping data of the temporary shipment record with the data found in the Predictive Bill Entry Engine, wherein a match is found between the elements of shipping data of the temporary shipment record and the data in the Predictive Bill Entry Engine, a Pre-Bill is automatically created. In some cases, wherein a match is found between two or more elements of shipping data of the temporary shipment record and the data in the Predictive Bill Entry Engine and some elements of shipping data are missing or incorrect, a Pre-Bill is manually edited. In alternate embodiments, wherein a match is not found between two or more elements of shipping data of the temporary shipment record and the data in the Predictive Bill Entry Engine, a Pre-Bill is manually created.

A predictive pair is formed by any combination of two elements of shipping data of a manually generated Pre-Bill in which all combinations that form a predictive pair are saved in the Predictive Database.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other methods for carrying out the same purpose of the present invention. It should be also realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood form the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 shows system layout/flow chart of for predictive Pre-Bill processing.

FIG. 2 shows a system layout/flow chart for predictive Bill processing.

FIG. 3 shows a flow diagram of the Computer Assisted Bill Entry (CABE) system.

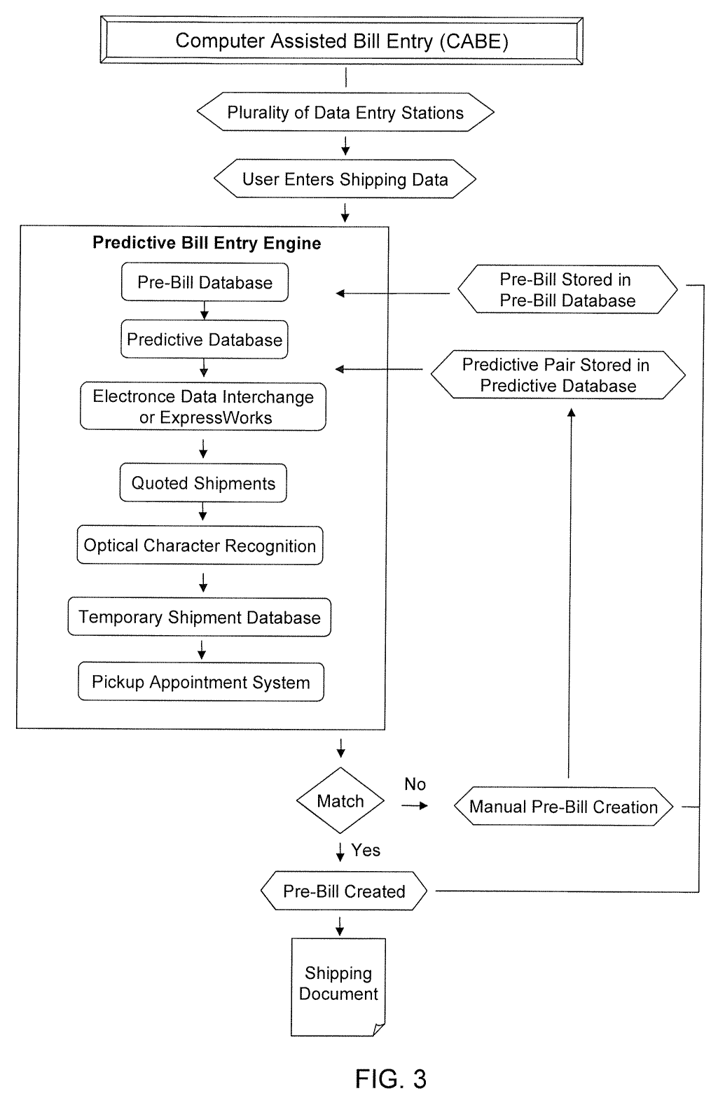

### DETAILED DESCRIPTION OF THE INVENTION

### I. Definitions

As used herein, “a” or “an” means one or more than one.

The term “predictive pair” as used herein is defined as two or more elements of shipping data.

The term “Predictive Bill Entry Engine” or “Predicted Bill Entry Engine” are used interchangeably and as used herein are defined as a compilation of databases which includes but is not limited to the Pre-Bill Database, Predictive Database, electronic data interchange database, ExpressWorks™, MyRoadway™, temporary shipment database, Quoted shipments, Optical character recognition, and pickup appointment system database.

The term “Pre-Bill” as used herein is defined as a temporary shipping document created manually by a user or automatically through the computer assisted bill entry method.

The term “Pre-Bill database” as used herein is defined as an electronic storage place for Pre-Bill data.

The term “data entry station” as used herein is defined as a place on the internet, world wide web or computer interface connected to a database wherein a user may enter or inspect shipping data.

The term “Predictive Database” as used herein is defined as a collection of associated elements of shipping data wherein two or more elements of shipment data form a predictive pair.

The term “temporary shipment database” as used herein is defined as a database that MyRoadway™ uses to store the bill of lading data for the Acquire Shipment Detail and Computer Assisted Bill Entry process to use and to access.

MyRoadway™ is a trademarked service “providing online information in the field of freight transfer services via global computer network.” The MyRoadway™ is owned by YRC Worldwide Inc. (YRC Worldwide Inc.; 10990 Roe Avenue; Overland Park, Kans. 66207; United States).

ExpressWorks™ is also a trademarked service comprised of computer programs for management services in the trucking industry. It is more specifically described as a Windows®-based, web-enabled, software program that integrates multi-carrier shipment information and tracking technology. ExpressWorks™ is owned by YRC Worldwide Inc. (YRC Worldwide Inc.; 10990 Roe Avenue; Overland Park, Kans. 66207; United States). It should be understood there are references to specific software and database products (for example, ExpressWorks, MyRoadway), these references are exemplary and any other software and database packages that substantially perform the same function are within the spirit and scope of the present invention.

### II. Computer Assisted Bill Entry

### CABE

The Computer Assisted Bill Entry (CABE) system reduces cycle time for processing shipping transactions, initial clerical costs for bill entry and revenue adjustments related to bill entry errors. Computer Assisted Bill Entry is possible because, for example, in analyzing eight months of shipping data (8,000,000 shipments) 305,000 pairs (shipments between the same shipper & consignee) were found. One requirement in identifying a pair is that there must be more than five shipments between the same shipper and consignee. Four million of the 8 million shipments are associated with one of the 305,000 identified shipper/consignee pairs. CABE uses these shipper/consignee pairs or trends in shipping behavior to predict shipping data which shifts the bill entry process to a bill review process.

By shifting the bill entry process to a bill review process baseline productivity is improved. For example, baseline bill entry is done at a rate of 24.12 bills entered per hour. In one day of using CABE, productivity jumped to 35.85 bills entered per hour. The shift from a bill entry process to a bill review process resulted in a 49% (11.73 bills entered per hour) increase in productivity. After becoming acclimated to the CABE system users average 40 computer assisted bills entered per hour. Some daily averages can be as high as 45 computer assisted bills entered per hour and in some cases individual users have entered over 95 computers assisted bills in one hour. On a nightly basis about 40% of the total bills are computer assisted bill entries or CABE eligible bills.

### A. Data Entry Stations

The CABE system provides for the capture of shipping information at the time of quotation for shipping services, pickup request, or pickup. This capture of shipping information is done when a user enters data at a data entry station. In some examples of the present invention, a plurality of data entry stations maybe used for Pre-Bill creation. The data entry stations can be remotely located regional data entry locations or any location where shipping documents are processed.

### B. Data Entry

During the research to develop the CABE system, the shipper/consignee pair was used to identify over 300,000 reoccurring shipments between the same shipper and consignee. This shipper/consignee or predictive pair was then used in the CABE system to expedite the bill entry process. There are a number of fields or elements of shipping data that can be used to form a predictive pair. The elements of shipping data used to form predictive pairs include but are not limited to: advance connecting line carrier identification code, advance commission agent indicator, codeword, commodity description, company code, consignee customer identification number, consignee city, consignee componentized address, consignee country, consignee name, consignee phone number, consignee state, consignee store number, consignee attention line, consignee zip code, customer type indicator, consignee servicing terminal, cubic feet, density, dimensions, chemical indicator, food indicator, freeze indicator, freeze temperature, payment terms; guaranteed services; handling unit, hazardous material indicator, hazardous material phone number, hazardous material identification number, line item bump indicator, new/used machinery indicator, used machinery released value, shipper servicing terminal, package type, packing list indicator, reference number type, shipper routing carrier identification code, service indicator, shipment purpose, shipper customer identification number, shipper city, shipper componentized address, shipper country, shipper name, shipper phone number, shipper state, shipper store number, shipper load and count indicator, third party attention line, third party customer identification number, third party city, third party componentized address, third party country, third party name, third party state, third party store number, and weight. The predictive pair can be formed with at least two of the entered elements of shipping data.

### C. Predictive Bill Entry Engine

In one aspect of the present invention, there is a system that includes a plurality of data entry stations, at which operators enter data into the Bill Database or the Predictive database, a computer database of predictive data, a computer database of Bill data, and a computer processor for operating the Predictive Bill Entry Engine. The system may also include but is not limited to other databases and computer systems including Pre-Bill Database, Predictive database, Electronic Data Interchange database, ExpressWorks™ database, Quoted shipments database, Optical character Recognition, and pickup appointment system database. The Predictive Bill Entry Engine is comprised of each database used to identify a predictive pair and/or create a pre-bill based upon a predictive pair.

### D. Pre-Bill Creation

After the user enters the shipping information, a temporary record is generated. Then the temporary record is compared with the information in the predictive bill entry engine. If there is a match, a Pre-Bill will be automatically generated for the user to review. Once the user confirms the data in the automatically generated Pre-Bill, the shipping data of the Pre-Bill is stored in the Pre-Bill Database and a shipping document is produced.

In certain situations, the Pre-Bill maybe manually generated. After the temporary record is compared with the information in the predictive bill entry engine and no match is found. The Pre-Bill must be manually generated. After the Pre-Bill is manually generated, the shipping data of the Pre-Bill is stored in the Pre-Bill Database and a shipping document is produced. The Pre-Bill Database tracks the number of times that a manually generated Pre-Bill is stored. If the Pre-Bill is generated and stored more than four times in a 13 month period, the data of the Pre-Bill is then stored in the Predictive Database. Once the Pre-bill shipping data is stored in the Predictive database then a predictive pair can be extracted from that data.

### E. Shipping Document

The Computer Assisted Bill Entry (CABE) system requires a minimal amount of shipping data to generate a complete shipping document. For example, using a predictive pair, the shipper customer identification number and the consignee customer identification number, a shipping document that contains elements of shipping data that include but are not limited to: advance connecting line carrier identification code, advance commission agent indicator, codeword, commodity description, company code, consignee customer identification number, consignee city, consignee componentized address, consignee country, consignee name, consignee phone number, consignee state, consignee store number, consignee attention line, consignee zip code, customer type indicator, consignee servicing terminal, cubic feet, density, dimensions, chemical indicator, food indicator, freeze indicator, freeze temperature, payment terms; guaranteed services; handling unit, hazardous material indicator, hazardous material phone number, hazardous material identification number, line item bump indicator, new/used machinery indicator, used machinery released value, shipper servicing terminal, package type, packing list indicator, reference number type, shipper routing carrier identification code, service indicator, shipment purpose, shipper customer identification number, shipper city, shipper componentized address, shipper country, shipper name, shipper phone number, shipper state, shipper store number, shipper load and count indicator, third party attention line, third party customer identification number, third party city, third party componentized address, third party country, third party name, third party state, third party store number, and weight.

### III. Examples

The following example is included to demonstrate preferred embodiments of the invention. It should be appreciated by those of skill in the art that the techniques disclosed in the examples that follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

The present invention provides a system and methods for processing the documents generated in shipping transactions that improves the productivity of bill entry while ensuring more accurate data. The system provides for computer assisted bill entry for processing the shipping transactions to reduce cycle time, initial clerical costs for bill entry, and reduce revenue adjustments related to bill entry errors.

In one aspect of the present invention, a system and method provides for the capture of shipping information at the time of quotation for shipping services, pickup request, or pickup. The shipping information is converted into a temporary shipment record. The Predicted Bill Entry Engine then compares the temporary shipment record to the Predictive Database. If a Predicted Bill Record exists, a Pre-Bill is created from the Predictive Database record.

Briefly, a system according to the invention includes a computer database of predictive data, a computer database of Pre-Bill data, a computer processor for operating the Predicted Bill Entry Engine, a plurality of data entry stations, at which operators enter data into the Pre-Bill Database or the Predictive database. The system may also include interfaces to other databases and computer systems including Electronic Data Interchange (“EDI”) systems, Optical Character Recognition (“OCR”), Quotation systems, among others.

A system according to the invention may also be configured as an entire integrated shipping transaction processing system. However, a shipping company may already have existing computer databases. For such companies a system according to the invention may be configured with separate database servers, which may be interfaced with the company's existing host computer database and procedures to provide predictive bill entry capability.

### Example 2

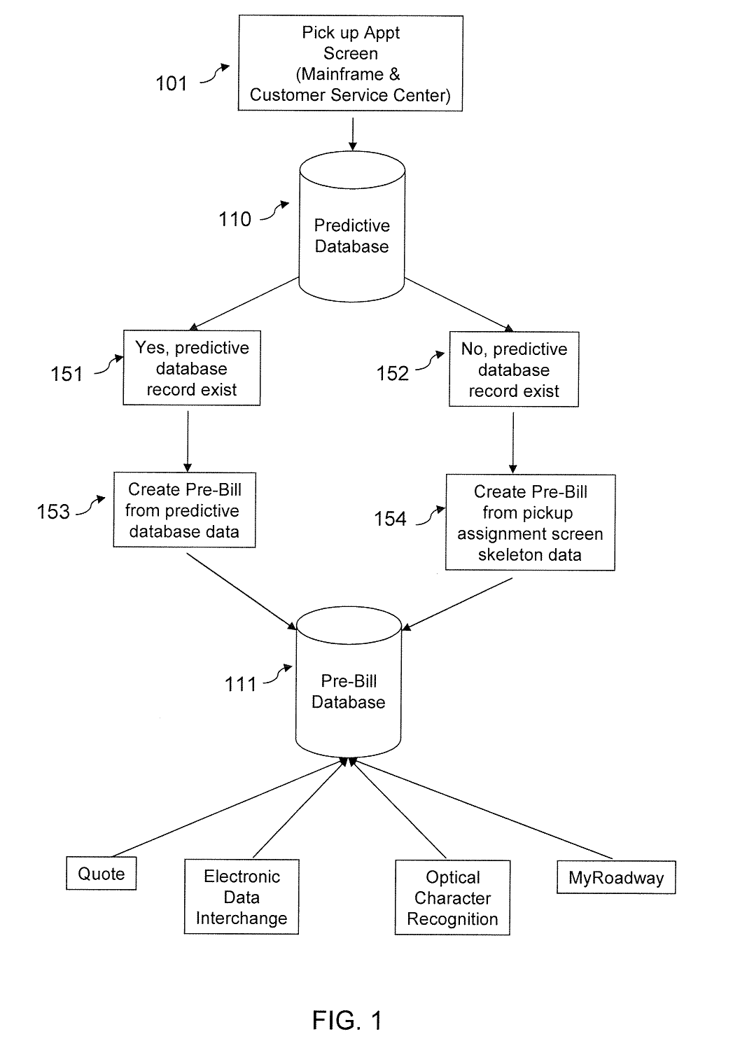

The methods and apparatus of the present invention will now be illustrated with reference to FIG. 1. It should be understood that this is merely illustrative and not exhaustive example of the scope of the present invention and that variations which are understood by those having ordinary skill in the art are within the scope of the present invention. FIG. 1 shows a system according to the invention for computer assisted bill entry using a Predictive Bill Entry Engine. The invention includes a plurality of data entry stations 201 for Pre-Bill creation. The data entry stations 101 may be remotely located regional data entry locations or any location where shipping documents are processed. The user enters shipping information which may include the shipper name and the destination zip code 101. The Predictive Bill Entry Engine then compares the shipping information with the records in the Predictive Database 110. If a Predictive Database record matching the shipping information is identified 151, a Pre-Bill 153 is created using the Predictive Database Record. The Pre-Bill record is then stored in the Pre-Bill database 111. Alternatively, if a matching Predictive Database record is not identified 152, the Pre-Bill is manually generated. In some cases, the a Predictive Database record matching the shipping information maybe identified with some incorrect elements of shipping data. In this situation, the CABE system allows for manual editing of the shipping data.

### Example 3

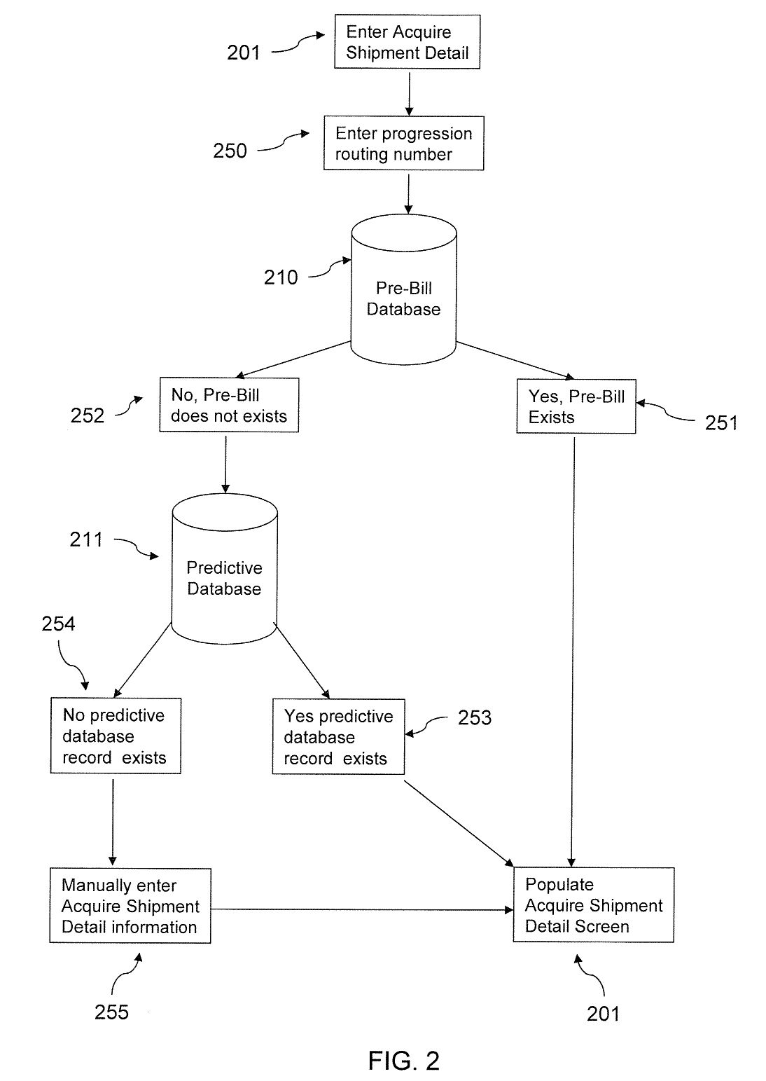

The methods and apparatus of the present invention will now be illustrated with reference to FIG. 2. It should be understood that this is merely illustrative and not exhaustive examples of the scope of the present invention and that variations which are understood by those having ordinary skill in the art are within the scope of the present invention. FIG. 2 shows a system according to the invention for computer assisted bill entry using a Predictive Bill Entry Engine. The invention includes at a plurality of data entry stations 201 for Bill creation. The data entry stations 201 can be remotely located regional data entry location or any location where shipping transaction documents are processed. The user enters shipping information which includes the progressive number, shipper name and destination zip code in step 250. The Pre-Bill Entry Engine then compares the shipping information to the records in the Pre-Bill database 210. If a Pre-Bill record matching the shipping information exists 251, then the Pre-Bill 256 is generated using the record in the Pre-Bill Database 210. In some cases, the a Predictive Database record matching the shipping information maybe identified with some incorrect elements of shipping data. In this situation, the CABE system allows for manual editing of the shipping data. If no matching record is found by the Pre-Bill Entry Engine, then the Predictive Database 211 is searched by the Predictive Bill Entry Engine. If a predictive record matching the shipping information is found 253, then the Bill is generated 256 using the Predictive Database record. If no matching record is found 254, then the Bill information is manually entered 255 to populate the bill 256.

### Example 4

The Predictive database is created during the initial load. During the initial load of the Predictive database, all consistent historical shipment information is manually loaded to create the database. For any one shipping document the elements of shipping data may include but are not limited to, advance connecting line carrier identification code, advance commission agent indicator, codeword, commodity description, company code, consignee customer identification number, consignee city, consignee componentized address, consignee country, consignee name, consignee phone number, consignee state, consignee store number, consignee attention line, consignee zip code, customer type indicator, consignee servicing terminal, cubic feet, density, dimensions, chemical indicator, food indicator, freeze indicator, freeze temperature, payment terms; guaranteed services; handling unit, hazardous material indicator, hazardous material phone number, hazardous material identification number, line item bump indicator, new/used machinery indicator, used machinery released value, shipper servicing terminal, package type, packing list indicator, reference number type, shipper routing carrier identification code, service indicator, shipment purpose, shipper customer identification number, shipper city, shipper componentized address, shipper country, shipper name, shipper phone number, shipper state, shipper store number, shipper load and count indicator, third party attention line, third party customer identification number, third party city, third party componentized address, third party country, third party name, third party state, third party store number, and weight. Anyone element of shipping data coupled with another element of shipping data from the same shipping document makes a predictive pair. For example, the Predictive database is populated with shipper/consignee or shipper/third party pairs, or predictive pairs.

For example, a predictive pair is identified when four or more shipments within a specified time frame that contain the same shipper/consignee or shipper/third party pair. The predictive pair is then stored in the Predictive Database. The Predictive database may be updated on a routine basis, and/or the Predictive Database Engine can track the occurrence of predictive pairs and update the Predictive Database when the four or more shipments occur and remove predictive pairs if less than four shipments occur during the specified time frame, such as within 13 months.

In certain examples of the present invention, the use of the progressive routing order number, shipper name, and destination zip code, other shipping fields can be used to predict the bill. In other examples, the fields that can be used include: shipper name and consignee name; pickup zip code and consignee name; shipper name and item shipped; there are many possibilities.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for computer assisted bill entry, wherein the method comprises:
entering elements of shipping data;
creating a temporary shipment record
comparing the elements of shipping data in the temporary shipment record with predictive pairs of shipping data found within the Predictive Bill Entry Engine;
creating a Pre-Bill;
storing the Pre-Bill data into a Pre-Bill database and
creating a shipping document.

2. The method of claim 1, wherein the elements of shipping data comprise two or more of: advance connecting line carrier identification code, advance commission agent indicator, codeword, commodity description, company code, consignee customer identification number, consignee city, consignee componentized address, consignee country, consignee name, consignee phone number, consignee state, consignee store number, consignee attention line, consignee zip code, customer type indicator, consignee servicing terminal, cubic feet, density, dimensions, chemical indicator, food indicator, freeze indicator, freeze temperature, payment terms; guaranteed services; handling unit, hazardous material indicator, hazardous material phone number, hazardous material identification number, line item bump indicator, new/used machinery indicator, used machinery released value, shipper servicing terminal, package type, packing list indicator, reference number type, shipper routing carrier identification code, service indicator, shipment purpose, shipper customer identification number, shipper city, shipper componentized address, shipper country, shipper name, shipper phone number, shipper state, shipper store number, shipper load and count indicator, third party attention line, third party customer identification number, third party city, third party componentized address, third party country, third party name, third party state, third party store number, and weight.

3. The method of claim 1, wherein the elements of shipping data are entered at a data entry station in which the data entry station comprises a computer interface associated with an existing database of the Predictive Bill Entry Engine.

4. The method of claim 1, wherein the Predictive Bill Entry Engine comprises the Pre-Bill Database, Predictive Database, Electronic Data Interchange database, ExpressWorks™ database, Quoted shipments, Optical Character Recognition, temporary shipment database, MyRoadway™ and pickup appointment system database.

5. The method of claim 1, wherein when a match is found between the elements of shipping data of the temporary shipment record and the data in the Predictive Bill Entry Engine, a Pre-Bill is automatically created.

6. The method of claim 1, wherein when a match is found between the elements of shipping data of the temporary shipment record and the data in the Predictive Bill Entry Engine where some elements of shipping data are missing or incorrect, a Pre-Bill is manually edited.

7. The method of claim 1, wherein when a match is not found between the elements of shipping data of the temporary shipment record and the data in the Predictive Bill Entry Engine, a Pre-Bill is manually created.

8. The method of claim 7, wherein any combination of two elements of shipping data of a manually generated Pre-Bill form a predictive pair and all combinations of a predictive pair are saved in the Predictive Database.
